(19) United States
(12) Patent Application Publication
(10) Pub. No.: US 2003/0187755 A1
(43) Pub. Date: Oct. 2, 2003

(54) Method and system for providing portable shopping information

(76) Inventors: Kamal Acharya, Los Altos, CA (US); Vincent Tong, Alameda, CA (US); Peter Gremett, Sunnyvale, CA (US); Louise Liu, Fremont, CA (US); Matthew Crampton, Mountain View, CA (US); Ellen F. Butler, San Francisco, CA (US)

Correspondence Address: GLENN PATENT GROUP, 3475 EDISON WAY, SUITE L, MENLO PARK, CA, 94025, US

(21) Appl. No.: 10/115,028

(22) Filed: Apr. 1, 2002

(51) Int. Cl. G06F 17/60

(52) U.S. Cl. 705/27

(57) ABSTRACT

Portable, instant, and personalized online shopping information and assistance is disclosed for a fast and filtered shopping experience that enables online shoppers to print, download to a portable device, or share the useful portion of the online shopping information with another person. Online shoppers may print or email the useful portion of the online shopping information in a brochure-style format for off-line browsing. The disclosed invention saves shopping time for selective and busy shoppers, attracts more physical product or service retail outlets to join online shopping services, and retains the existing online product or service providers.

### BACKGROUND OF THE INVENTION

1. Field of the Invention

The invention relates to online shopping. More particularly, the invention relates to a system and a family of methods that provide portable shopping information that may be printed in a brochure format and/or emailed to another person.

2. Description of Related Technology

Present online shopping service providers do not provide portable, personalized, and comprehensive online shopping information that may be efficiently printed, or emailed to another person. Currently, online shoppers have to view the online shopping either when they are logged onto an online shopping service provider's home page, or they have to print or download the whole shopping information for off-line viewing.

Current online shopping service providers do not allow online shoppers to print the useful version of the online shopping information in a brochure format, without the extraneous link and navigation information.

Current online shopping service providers do not allow online shoppers to email the useful version of the online shopping information to another person.

There is a need, therefore, for online shopping service providers that provide an online shopper with the ability to efficiently print and/or download the useful version of the shopping information to a portable device, such that the shopper may view the shopping information off-line. There is also a need to provide an online shopper with the ability to email the useful version of the shopping information to another person.

### SUMMARY OF THE INVENTION

One presently preferred embodiment of the invention provides a system and a method for printing the useful version of the online shopping information in a brochure-style format. The printed information may include information about a product as well as at least one favorite provider of the product. The shopping information may also include personalized shopping information about the special-sale and popular items that are provided by the shopper's favorite provider. The online shopping information may also include information about personalized shopping lists of favorite items, where the personalized shopping lists may include shopping lists related to the shopper and shopping lists related to persons other than the shopper.

Another presently preferred embodiment of the invention provides a system and a method for sharing the useful version of the online shopping information with another person, which may include emailing the information.

### BRIEF DESCRIPTION OF THE DRAWINGS

FIG. 1 shows a representation of an exemplary online shopping information page according to one embodiment of the invention;

FIG. 2 shows a representation of an exemplary favorite providers information page;

FIG. 3 shows a representation of an exemplary shopping list information page;

FIG. 4 shows a representation of an exemplary search page;

FIG. 5 shows a representation of an exemplary gift ideas and specialty shops information page;

FIG. 6 shows a flow chart for searching online shopping information according to one embodiment of the invention;

FIG. 7 shows a representation of a search result according to one embodiment of the invention;

FIG. 8 shows a representation of an exemplary product page;

FIG. 9 shows a representation of an exemplary printed page;

FIG. 10 shows a representation of an exemplary email page; and

FIG. 11 shows a representation of an exemplary system for providing portable shopping information.

### DETAILED DESCRIPTION OF THE INVENTION

The invention contemplates a new and unique system and a family of methods for providing portable online shopping information, which may be implemented in a network of computer systems, such as the Internet. A computer system may include user terminals, storage devices, processing units, input and output devices, and networking devices and software modules.

Online shoppers may include those shoppers who both search and purchase their products or services online, and those bargain-seeker shoppers who may take the information they obtain from online search results to off-line local providers, looking for special sales and/or coupons. Therefore, current online shopping service providers lose revenue unless they attract and retain more online shoppers by providing them portable, personalized, instant, and comprehensive online shopping information. The online shopping information may preferably be provided when a shopper signs onto an online shopping service provider's Web page, and may be linked to the same Web page that the online shopping service provider provides for online shopping. The shopper may print a useful version of the online shopping information in a brochure-like format, without extraneous information; and may share the useful version of the online shopping information with another person, which may include emailing the information.

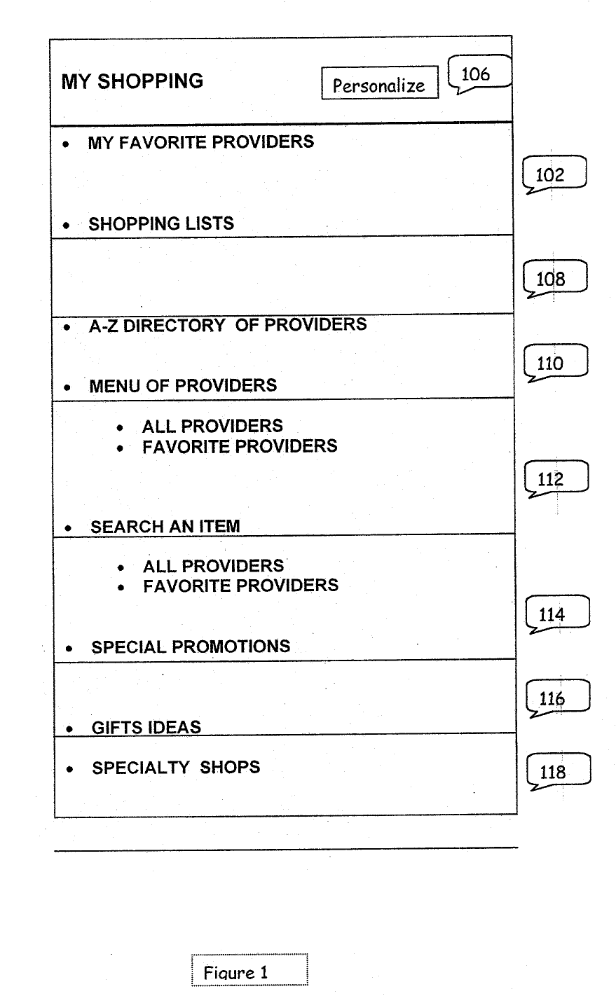

FIG. 1 shows a representation of an exemplary online shopping information Web page that may be presented to a shopper according to one preferred embodiment of the invention. After the shopper signs onto an online shopping service provider's Web page, or when the shopper indicates that he is interested in online shopping, a personalized shopping information page may be instantly and automatically presented to the shopper. The shopping information page may be seamlessly connected to the shopping service provider's home page. If the shopper is revisiting his or her personalized shopping information page, items of shopping information as shown in FIG. 1, for example, may have been personalized for him. On the other hand, if the shopper is visiting the shopping information page for the first time, he may customize the shopping information page, as shown in FIG. 1, by activating the “Personalize” icon 106, as will be discussed below.

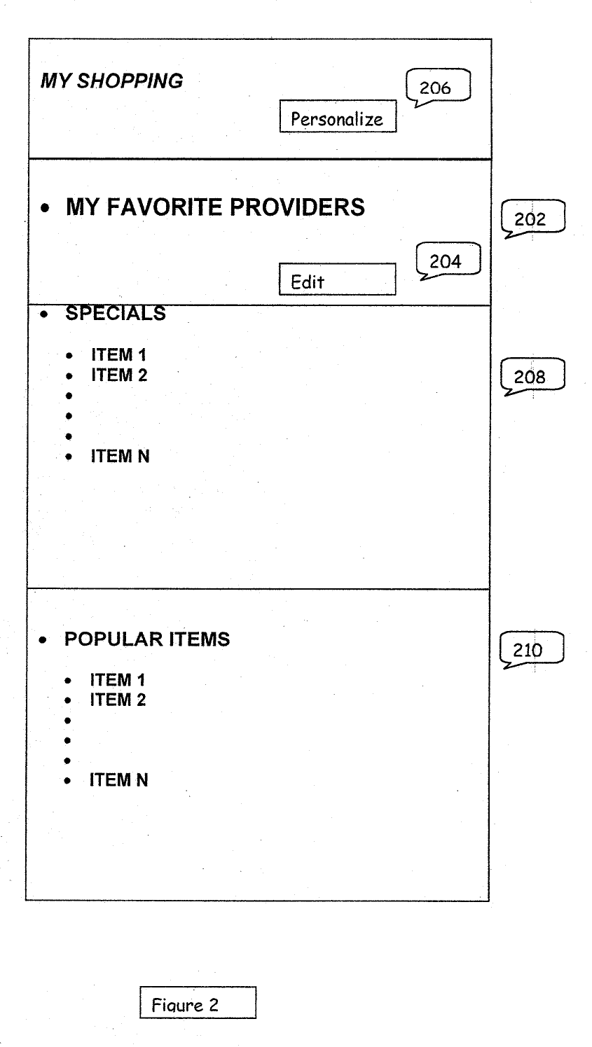

The shopping information item 102 may provide a link to a shopping information page, which may include a personalized shopping information page about the shopper's favorite or preferred providers of products or services, such as favorite department stores and specialty shops. When the shopper activates the shopping information item 102, the exemplary shopping information page “MY FAVORITE PROVIDERS,” as shown in FIG. 2, may be displayed. The shopper may edit his list of favorite providers by selecting the edit icon 204. After the shopper selects the edit icon 204, a directory of shopping categories of providers may be provided to the shopper. The directory may be an alphabetical directory of shopping categories such as “toys and games,” “electronics,” and “music and books.” After the shopper selects a favorite shopping category, e.g. “toys and games,” a list of online as well as off-line providers for the selected shopping category may be provided to the shopper. The shopper may select a number of favorite providers, e.g. providers “A” and “B,” that provide the selected shopping category, e.g. “toys and games.” The shopper may save the selected favorite providers. In one embodiment, the shopper may save the list of his selected favorite providers under “my favorite providers” shopping information item by selecting the “personalize” icon 206. Selecting icon 206 may cause the display of a menu, which may include “customize,” “remove,” and “help” menu items. The shopper may also select a provider and view the corresponding provider page, as will be discussed later in this application.

According to one embodiment of the invention, the shopping information page in FIG. 2 may include information about “specials” 208 and “popular products” 210, which may be provided by the shopper's favorite providers. The information item “specials” 208 may provide the list of products or services that are on special sale, and the “special products” information item 210 may provide the list of products and services that have recently hit the market. The information items “specials” and “popular products” may be programmed contents, meaning that they may be programmed and/or regularly updated, based on the input or request information received from the partner-providers.

In the present exemplary embodiment, the items under “toys and games” that are on special sale by the favorite providers “A” and “B” may be listed under “specials” for the shopper. The shopper may select an item from the list of specials and/or popular items. More information about the selected item may be provided, including a photo, price, description, one or more provider for the selected item, a direct link to the “product page,” and a direct link to one or more “provider page” for the selected item. The shopper may select the direct link to a provider of the selected item to view the provider page, which may provide information about the provider, information about other similar items along with their corresponding description, price, and availability. The shopper may also select a product to view, print, and or download a useful version of the corresponding product page, as will be discussed later in this application.

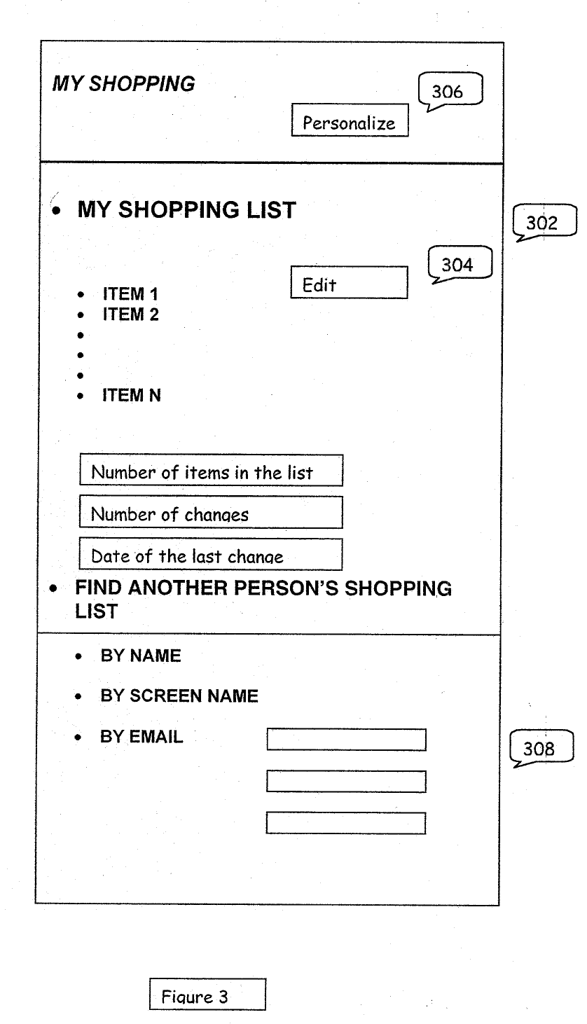

The shopping information item 108 may provide a link to a shopping information page about shopping lists of favorite or desired products or services, which may have been previously compiled by shoppers. When the shopper activates the shopping information item 108, the exemplary shopping list information page “MY SHOPPING LISTS,” as shown in FIG. 3, may be displayed. The shopping list information page may provide information about public and private forthcoming special occasions and the corresponding gift ideas. The shopping list information page may also provide an indication for recent changes to the shopping list, and/or the number of items currently on the shopping list. The shopping list information page in FIG. 3 may provide information about “my shopping list” 302 that relates to the shopper. The shopper may cause the display of his or her shopping list by selecting the “my shopping list” icon. The list may include information about the products in the list, including a photo, price, description, one or more provider for the product in the list, the date a product was put on the list, a direct link to the “product page,” and a direct link to the “provider page” for each product in the shopping list. The shopper may edit this list by selecting the edit icon 304.

The shopper may select the direct link to a provider of a selected product in the shopping list to view the provider page, which may show information about the provider, information about other similar items along with their corresponding description, price, and availability. The shopper may also select a product and view the corresponding product page. More details about viewing, printing, downloading, and sharing a useful version of the provider page and the product page will be discussed later in this application.

The shopper's shopping list may be removed from the list by selecting a “remove” icon. In one embodiment, the shopper may personalize his or her complied shopping list under “my shopping list” information by selecting the “Personalize” icon 306. Selecting the icon 306 may cause the display of a menu, which may include “customize,” “remove,” and “help” menu items.

The shopping list information page in FIG. 3 may also provide information about a shopping list that relates to a person other than the shopper. The shopper may access this shopping list by activating the “Find another person's shopping list” icon 308. Searching for another person's shopping list may be based on the person's name, screen name, or e-mail information. If the other person's shopping list is public, the shopper may access it and add it to his or her shopping list. If, however, the other person's shopping list is private, the shopper may request, e.g. via e-mail, the owner of the shopping list for access authorization and instruction. The other person may provide permission and access information to the shopper for accessing his or her private shopping list. The shopper may then search, view, and add the other person's shopping list to his shopping list, e.g. by selecting a “click-to-add” feature embedded in the email received from the other person.

The shopping information item 110 may provide a shopping information page about a directory of providers of products or services. When the shopper activates the shopping information item 110, a shopping directory information page “A-Z DIRECTORY OF PROVIDERS” may be displayed to provide an alphabetical list of all partner-providers or an alphabetical list of favorite providers for the shopper. The directory may also include information indicating whether a provider provides “quick checkout wallet.” The directory may include a search box for searching a provider using either a provider's name or a description keyword. The shopper may add a selected provider from the directory of providers to his or her favorite provider list.

The shopping information item 112 may provide a link to a shopping information page about providers of the products and service. When the shopper activates the shopping information item 112, a shopping information page “MENU OF PROVIDERS” may be displayed to provide an alphabetical list of “all providers,” which are partner-providers, and/or an alphabetical list of favorite providers for the shopper. The list of providers may include online as well as off-line local providers, as will be discussed later. The menu may include a search box for searching a provider using either a provider's name or a description keyword. The shopper may add a selected provider from the menu of providers to his or her favorite provider list.

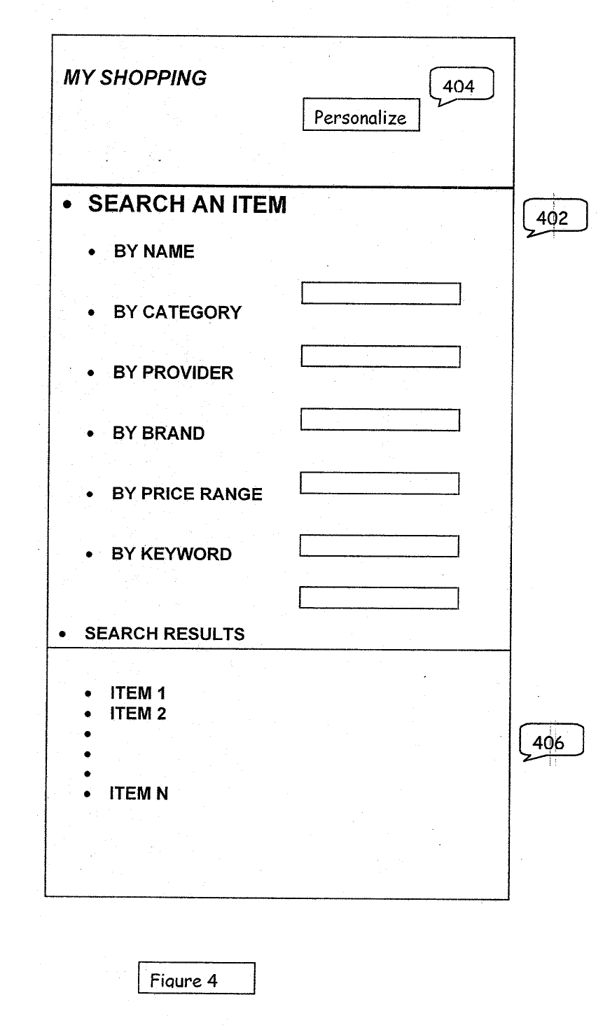

The shopping information item 114 may provide a shopping information page about searching a product or service. When the shopper activates the shopping information item 114, the exemplary shopping information page “SEARCH AN ITEM,” as shown in FIG. 4, may be displayed. The shopping information page may provide a search box for searching an item under “ALL PROVIDERS” OR “FAVORITE PROVIDERS.” The shopper may use the search section 402 to search an item based on the item's name, descriptive keyword, shopping category, brand name, or a price range. The shopper may personalize the shopping information page for searching an item by activating the “personalize” icon 404. The shopping information page in FIG. 4 may provide a list of items and at least one provider for each item in a search result section 406. The shopper may select a provider for the searched item, and add it to his or her favorite provider list.

The shopping information item 116 may provide a link to a shopping information page about “SPECIAL PROMOTIONS”, which may include special sales running on products or service. Special promotions provided under this shopping information item may be the same special items that may be provided under the shopping information item 102. The special promotions information may be personalized for the shopper, providing special promotions tailored to the shopper's favorite shopping category or providers. The information item 116 may include a search box for searching an item based on the item's name, descriptive keyword, shopping category, or brand name. The shopper may select a provider from the list of items in the special promotion, and add it to his or her favorite provider list. The special promotions such as coupons and prizes may be matched to a product page, and may be printed together with the product information, as will be discussed later in this application.

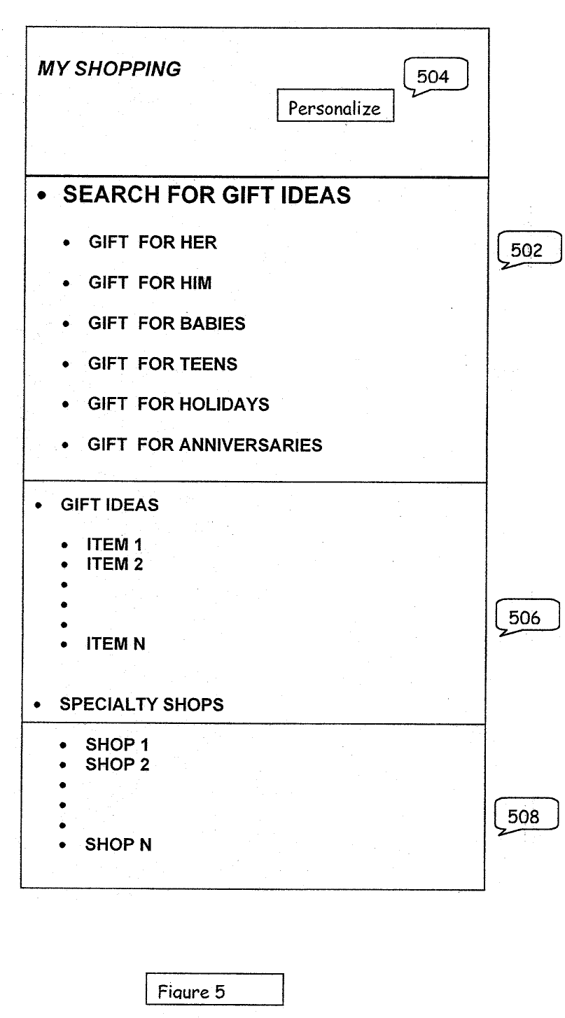

The shopping information item 118 may provide a shopping information page about gift ideas and specialty shops. When the shopper activates the shopping information item 118, the exemplary shopping information page, as shown in FIG. 5, may be displayed. The shopping information page in FIG. 5 may provide gift ideas for a forthcoming special occasion, for a holiday, for a charity, for another person on the shopper's shopping list, for her, for him, for teens, for a baby, and for a price range. The gift ideas search section 502 may include search boxes for searching gift ideas based on an occasion, a descriptive keyword, a shopping category, or a brand name. The shopper may personalize his search information by activating the “Personalize” icon 504. The shopping information section 506 provides a list of search ideas. The shopper may select a provider from the list of gift ideas, and may add it to his or her favorite provider list. The shopper may select a product or a provider of a product to view the respective Web pages, and may print, download, and/or share a selected portion of the shopping information with another person, as will be discussed later in this application.

The shopping information page in FIG. 5 may provide information about “SPECIALTY SHOPS” 508 that may provide specialty shops for a special occasion, for a holiday, for a charity, for another person on the shopper's shopping list, for her, for him, for teens, and for a baby. The shopping information page in FIG. 5 may also include search boxes for searching specialty shops based on a specialty shop's name, a descriptive keyword, a shopping category, or a brand name. The shopper may select a provider from the list of specialty shops, and may add it to his or her favorite provider list. The shopper may select a product or a provider of a product to view the respective Web pages, and may print, download, and/or share the shopping information with another person, as will be discussed later in this application.

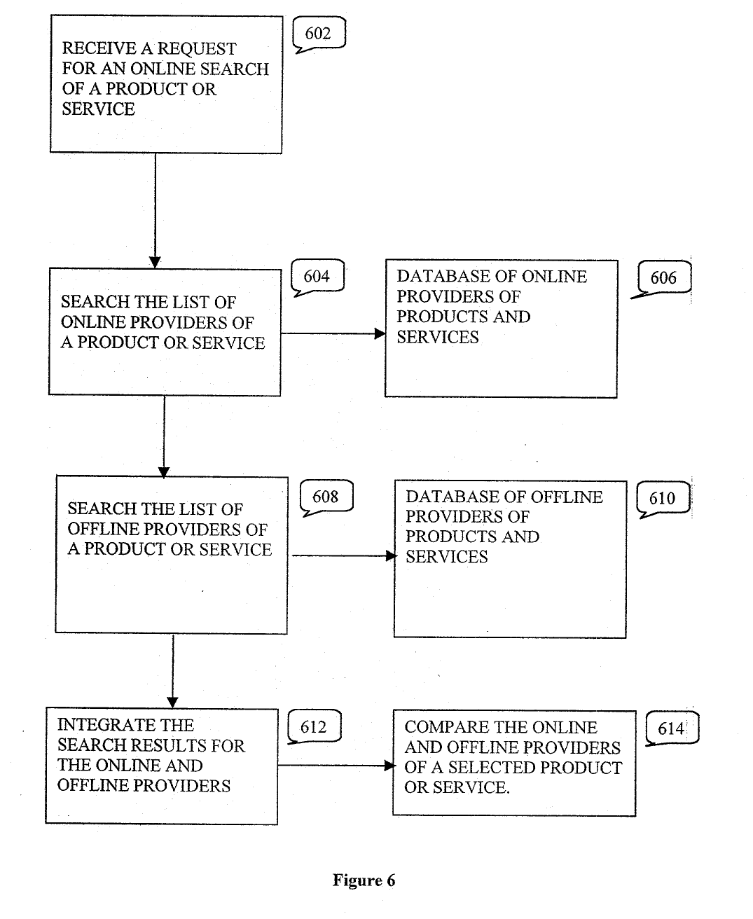

FIG. 6 shows a flow chart for a method of online search process for “SEARCH AN ITEM” 114 (FIG. 1), according to one embodiment of the invention. A shopper may request an online search for a product or service, in step 602. A shopper may request for a product/service search based on a category of products/services, such as toys, electronics, or cleaners. A shopper may also request for a product/service based on a name or an identification code of a specific product or service, such as a game, a television set, or a carpet cleaner. A request for a product or service may be also based on a name or an identification code of a product/service provider, such as a specific toy store, a specific electronics distributor, or a specific cleaner. A search request for a product or service may be limited to a geographical area. A desired geographical area may be identified by a shopper's city and state, zip code, and/or a target location. A geographical area may be limited to a proximity range, which may be defined by a default or a user-defined search radius about a target location.

After receiving an online search request for a product or service, according to one embodiment of the present invention, a search may be conducted for both online and off-line providers of the desired product or service. In step 604, the database 606, which contains information about online providers, may be searched. The database 606 refers to the “pure-play e-tailers,” which include those online providers with a Web storefront that may not have physical retail outlets. They may allow the shoppers to trade with them only through online shopping.

In step 608, the database 610, which contains information about off-line providers, is searched. The off-line providers may include the off-line “brick-&-mortar” providers, which have physical retail outlets but no Web storefront, such as local mom-&-pop stores. The off-line providers may also include the off-line “click-&-mortar” providers, which have physical retail outlets as well as Web storefront. These off-line providers may allow the shoppers to trade with them either online or off-line.

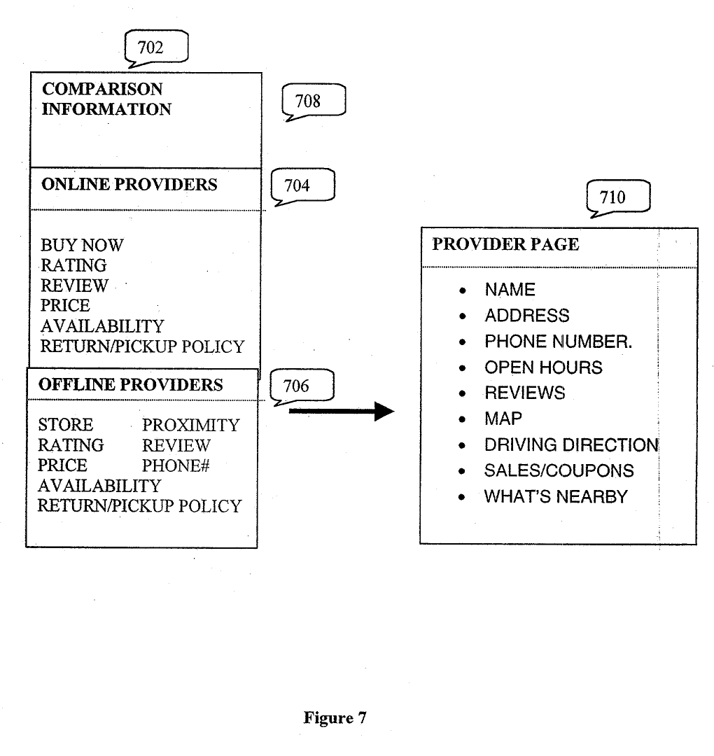

In step 612, the search results for both online and off-line providers may be combined to generate an integrated search result for the desired product or service. FIG. 7 presents an exemplary integrated product page 702. A product page may include a first portion 704, pertaining to the online providers that carry the desired product or service, and a second portion 706, pertaining to the off-line providers that carry the same product or service.

In step 614, the online providers of a desired product or service may be compared to the off-line providers of such product or service. The product page 702 may also include a third portion 708 that may provide comparison information of online and off-line providers of a selected product or service. The comparison information may be based on providers rating, product/service price, product/service availability, user review, professional/expert review, and/or return/pickup policies. Therefore, the bargain-seeker shoppers may conveniently get the providers comparison information online, and may confidently do more online shopping. This attracts more shoppers to do online shopping, attracts more “brick-&-mortar” off-line providers to join online shopping services, and retains more “pure-play e-tailer” online providers.

The list of off-line providers of a product or service may be based on a target geographical location. Shoppers may choose such target locations to be their home, work, or other locations. A shopper may choose one of several target locations, which may have been already created and stored for future use. The list of off-line providers may be prioritized based on a desired factor, such as proximity to a target location, price, rating, or user and/or expert review.

When an online shopper selects an off-line product service provider from a product/service page 706, the shopper may receive detailed information about the selected off-line provider. The product/service page section 706 may contain a direct link to a provider page 710 that provides detailed information for a selected off-line provider. Such detailed information may include a provider's business name, address, phone number, photo, map, working hours, rating, user and/or expert reviews, driving direction, sales and/or coupons, and in-store pickup and/or return policies of online purchases. The off-line providers may regularly update their information.

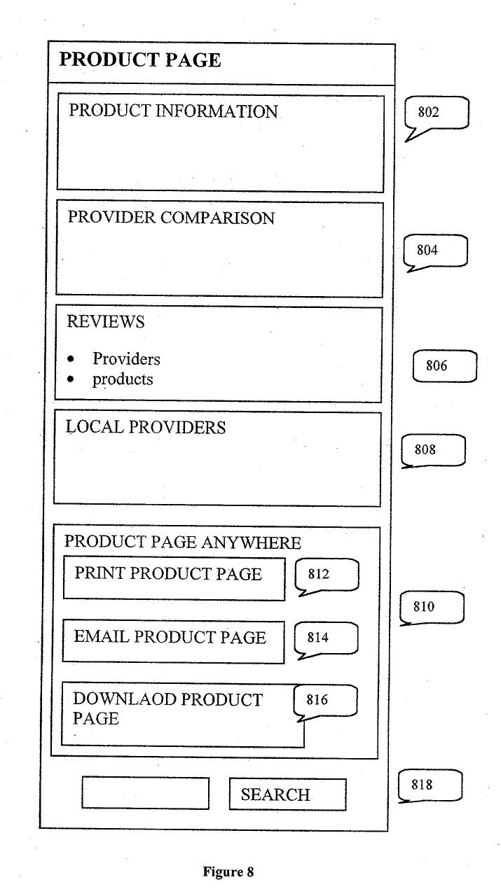

FIG. 8 shows an exemplary “product page,” according to one embodiment of the present invention. The product page may be obtained by searching a product under the several options as discussed above in reference to FIG. 1. The product page may provide “product information” 802, which may include a photo, description, and price. The product page may provide “provider comparison” 804, which may include information as described above in reference to FIGS. 6 and 7. The product page may provide “reviews” 806, which may include user review and professional/expert review of a product or provider. The product page may provide “local provider(s)” 808 of the product or service, as discussed above in reference to FIGS. 6 and 7.

According to one embodiment of the present invention, shopping information, such as product page, provider page, shopping list, special products, or popular products, may be provided in portable formats. For example, the product page in FIG. 8 may include “product page anywhere” 810 portion that may include options for providing portable shopping information. The product page may include the option “print product page” 812 for printing a version of the online shopping information such as a product page. When selected, the print option may re-format the shopping information for optimal printing, which may include removing the interactive and navigational elements from the product page. The extraneous information removed from the product page may include search boxes, menus, and other elements that are not relevant for off-line viewing of the product page. Thus, the printed product page may only include easy-to-read and attractive brochure-style product information. The shopper may also print a shopping list page by a single-click print operation to print a summary of the product page information for the selected items in the shopping list.

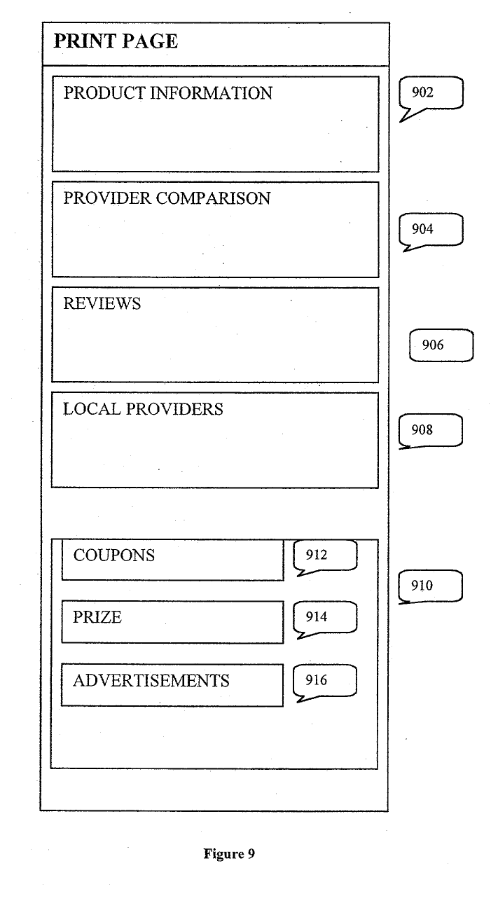

FIG. 9 shows an exemplary printer friendly “Print page” for the product page that provides useful information for off-line viewing of the product page. Compared to the product page in FIG. 8, the interactive elements “product page anywhere” 810 and “search” 818 are removed. The print page in FIG. 9 may include promotional information such as coupons 912, prizes 914, and advertisements 916.

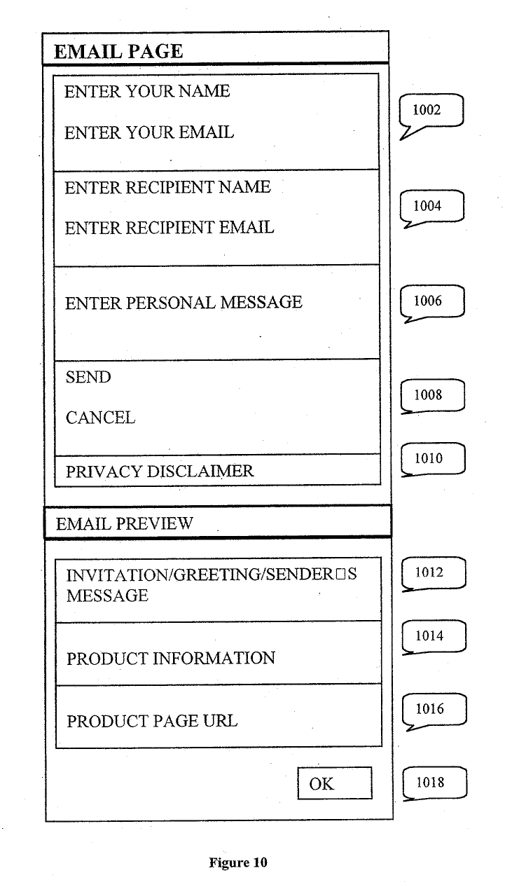

The exemplary product page in FIG. 8 may also include the option “email product page” 814 for sharing a version of the online shopping information, such as a product page, to another person. The invention is not limited to sharing only product page, since other shopping information, such as a provider page, a shopping list, and special and popular products may be shared. When a shopper selects the email option 814, an exemplary email page as shown in FIG. 10 may be provided to the shopper. The shopper may provide his name, screen name, or email 1002, as well as those of the recipient 1004, and enter personal message, greetings, and/or invitations 1006. The email page may also provide a preview of the email, which may include the personal invitation, greetings, and/or message 1012, product information 1014, and the URL address 1016 of the product page. The shopper may confirm sending or canceling 1008 the email by activating the “OK” icon 1018. After the recipient receives and views the email, the sender may receive a confirmation email.

When selected, the email option may re-format the shopping information to generate a useful version of the shopping information, which may include removing the interactive and navigational elements from the product page. The extraneous information removed from the product page may include search boxes, menus, and other elements that are not relevant for off-line viewing of the product page. Thus, the emailed product page may only include easy-to-read and attractive brochure-style summary of the product information. The useful version of the online shopping information may be emailed to another person when the shopper links or synchronizes with an online service provider through a global telecommunications network, such as the Internet.

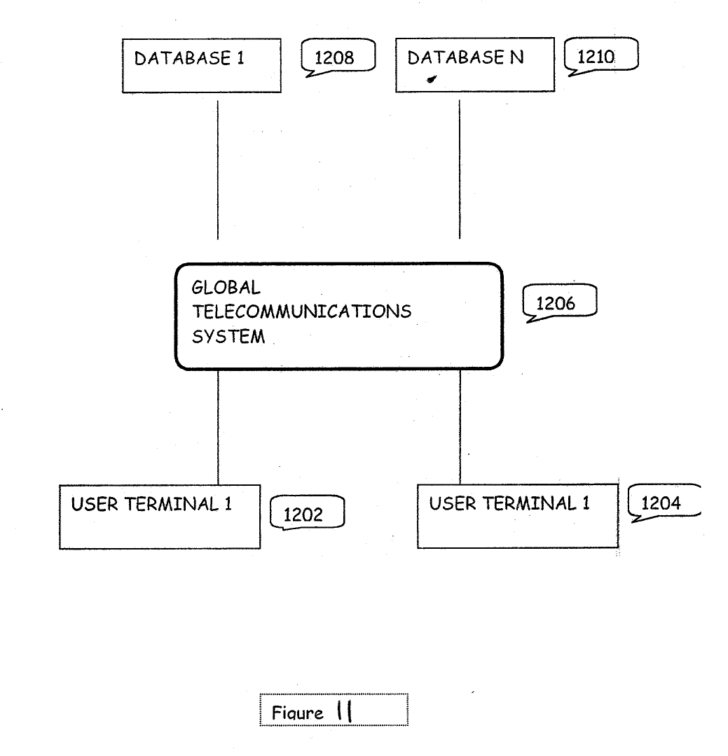

FIG. 11 shows a representation of an exemplary system for providing portable shopping information according to one embodiment of the invention. The user terminals 1202, 1204 may include the hardware and software modules to implement the disclosed invention. The user terminals may also include the necessary devices and software modules to connect to the global telecommunication network 1206, which may include the Internet. A shopper may use a user terminal to search, view, print, download, or email a useful version of the online shopping information that may be warehoused in the databases 1208, 1210. The shopping service providers or system managers may regularly update the databases.

The method and system disclosed herein provides portable, personalized, instant, comprehensive, and relevant online shopping information and assistance all in one shopping information page. The disclosed invention also provides a customized and filtered comparison shopping experience that enables online shoppers to shop online conveniently and confidently, knowing that they are getting their desired product and service from their favorite department stores or shops. The method and system of the present invention further provides access to the personalized shopping lists owned by the shopper as well as the shopping lists owned by other persons.

The system and method disclosed herein saves shopping time, attracts more physical retail outlet stores to join online shopping service providers, and retains the online product or service providers.

Accordingly, although the invention has been described in detail with reference to particular preferred or exemplary embodiments, persons possessing ordinary skill in the art to which this invention pertains will appreciate that various modifications and enhancements may be made without departing from the spirit and scope of the claims that follow.

1. A method for printing online shopping information for a shopper, comprising the steps of:
receiving a request from the shopper to print the online shopping information;
generating a version of the online shopping information for printing; and
printing the version of the online shopping information.

2. The method of claim 1, wherein the receiving the request includes receiving a single request for printing the shopping information that is about a plurality of items.

3. The method of claim 2, wherein the receiving the request includes receiving a single-click input from the shopper.

4. The method of claim 1, wherein the generating the version includes stripping extraneous information from the online shopping information.

5. The method of claim 4, wherein the stripping extraneous information includes stripping hyperlink information.

6. The method of claim 4, wherein the stripping extraneous information includes stripping navigation information.

7. The method of claim 1, wherein the generating the version includes generating a summary of the online shopping information.

8. The method of claim 1, wherein the printing the version includes
printing the version in a brochure-style format.

9. The method of claim 1, wherein the printed version of the online shopping information includes product information page.

10. The method of claim 1, wherein the printed version of the online shopping information includes provider information.

11. The method of claim 1, wherein the printed version of the online shopping information includes promotion information.

12. A method for sharing online shopping information with a person other than a shopper, comprising the steps of:
identifying the online shopping information for sharing with the person;
generating a version of the online shopping information;
providing forwarding information for the person; and
sharing the version of the online shopping information with the person.

13. The method of claim 12, wherein the identifying includes searching the online shopping information.

14. The method of claim 13, wherein the searching includes searching for a shopping list for the shopper.

15. The method of claim 13, wherein the searching includes searching for information about products and services offered in a favorite shopping category.

16. The method of claim 13, wherein the searching includes searching for information about products and services offered by a favorite provider.

17. The method of claim 12, wherein the generating the version includes stripping extraneous information from the online shopping information.

18. The method of claim 17, wherein the stripping extraneous information includes stripping hyperlink information.

19. The method of claim 17, wherein the stripping extraneous information includes stripping navigation information.

20. The method of claim 12, wherein the generating the version includes generating a summary of the online shopping information.

21. The method of claim 12, wherein the providing includes providing email address for the person.

22. The method of claim 12, wherein the providing includes providing personal notes for the person.

23. The method of claim 12, wherein the sharing includes emailing the version of the online shopping information to the person.

24. The method of claim 23, wherein the emailing includes emailing when the shopper synchronizes with a global telecommunication network.

25. The method of claim 24, wherein the emailing includes emailing when the shopper synchronizes with the Internet.

26. The method of claim 12, further including providing confirmation information to the shopper that the person has viewed the shared version of the online shopping information.

27. A method for downloading online shopping information from a user terminal to a device, comprising the steps of:
identifying the online shopping information for downloading to the device;
generating a version of the online shopping information for downloading to the device;
receiving a request for downloading the version of the online shopping information to the device; and
downloading the version of the online shopping information to the device.

28. The method of claim 27, wherein the identifying includes searching the online shopping information.

29. The method of claim 28, wherein the searching includes searching for a shopping list for the shopper.

30. The method of claim 28, wherein the searching includes searching for the information about product and services offered in a favorite shopping category.

31. The method of claim 28, wherein the searching includes searching for the information about products and services offered by a favorite provider.

32. The method of claim 27, wherein the generating the version includes stripping extraneous information from the online shopping information.

33. The method of claim 32, wherein the stripping extraneous information includes stripping hyperlink information.

34. The method of claim 32, wherein the stripping extraneous information includes stripping navigation information.

35. The method of claim 27, wherein the generating the version includes generating a summary of the online shopping information.

36. The method of claim 27, wherein the receiving the request includes receiving a single request for downloading the version of the online shopping information that is about a plurality of items.

37. The method of claim 36, wherein the receiving the single request includes receiving a single-click input from the shopper.

38. The method of claim 27, wherein the receiving the request includes receiving a request from the device.

39. The method of claim 38, wherein the receiving the request from the device includes an indication that the device is linked to the user terminal.

40. The method of claim 38, wherein the receiving the request from the device includes an indication that the device is synchronized with the user terminal.

41. The method of claim 27, wherein the generating the version includes generating a brochure-style version of the online shopping information suitable for a portable device.

42. A computer readable medium embodying a method for providing a portable version of online shopping information, the method comprising the steps of:
identifying the online shopping information;
generating a version of the online shopping information, said version being suitable for delivery to a device.

43. A system for printing online shopping information, comprising:
at least one user terminal;
at least one database containing shopping information;
means for receiving a request from the shopper to print the online shopping information;
means for generating a version of the online shopping information for printing; and
means for printing the version of the online shopping information.

44. The computer system of claim 43, further implemented on a network environment.

45. The computer system of claim 44, wherein the network environment includes a global telecommunications network.
